(19) United States
(12) Patent Application Publication
(10) Pub. No.: US 2006/0028822 A1
(43) Pub. Date: Feb. 9, 2006

(54) Medical image viewing apparatus and method

(76) Inventors: Steven W. Tanamachi, Lauderdale, MN (US); Paul C. Schubert, Marie Saint Croix, MN (US); Donald H. Singley, Woodbury, MN (US)

Correspondence Address: Pamela R. Crocker;Patent Legal Staff, Eastman Kodak Company, 343 State Street, Rochester, NY, 14650-2201, US

(21) Appl. No.: 11/199,040

(22) Filed: Aug. 8, 2005

Related U.S. Application Data
(60) Provisional application No. 60/600,212, filed on Aug. 9, 2004.
(60) Provisional application No. 60/630,325, filed on Nov. 23, 2004.

(51) Int. Cl. F21V 9/10

(52) U.S. Cl. 362/293; 362/276

(57) ABSTRACT

A medical image viewing apparatus and method. In one embodiment, the apparatus is a light box assembly for viewing medical film media. The light box assembly includes an enclosure with a translucent viewing panel, at least two light emitting diodes disposed within the enclosure adapted to illuminate the viewing panel, and a controller controlling the color of the at least one light emitting diode. In a second embodiment, an apparatus is provided for displaying a digital x-ray image. The apparatus includes a display adapted to display the x-ray image and a controller in communication with the display for controlling the color of the displayed x-ray image. The controller includes a continuous color palette by which a color can be selected by a user and the color of the displayed x-ray image is changed responsive to the user's selection of the color.

### CROSS REFERENCE TO RELATED APPLICATIONS

Reference is made to, and priority is claimed from, commonly assigned Provisional Patent Application U.S. Ser. No. 60,600,212 entitled “LIGHT BOX”, and filed on Aug. 9, 2004 in the name of Tanamachi, and which is assigned to the assignee of this application.

Reference is also made to, and priority is claimed from, commonly assigned Provisional Patent Application U.S. Ser. No. 60/630,325 entitled “DIGITAL MEDICAL IMAGE VIEWING APPARATUS AND METHOD”, and filed on Nov. 23, 2004 in the names of Tanamachi, Schubert, and Singley and which is assigned to the assignee of this application.

### FIELD OF THE INVENTION

The invention relates generally to viewing images, and more particularly, an apparatus and method employed in the field of medical imaging for viewing of medical images.

### BACKGROUND OF THE INVENTION

Light boxes are known devices capable of containing one or more light sources and useful for display purposes. Light boxes are often referred to by alternate names, for example, a viewing box, a viewing member/device, an illuminator, and the like.

Light boxes have been employed to serve as pictorial or advertising display units. For example, a box having at least one transparent or translucent side which either constitutes or carries a picture, legend or other display, such as shown in U.S. Pat. No. 4,242,821 (McNeil), U.S. Pat. No. 4,404,619 (Ferguson), U.S. Pat. No. 6,530,164 (Gai), U.S. Pat. No. 6,178,672 (Inbar), U.S. Pat. No. 6,011,528 (Inbar), and U.S. Pat. No. 6,246,450 (Inbar).

Light boxes have also been used for in the medical field for the displaying of transmissive/transparent film articles, such as x-ray film. More particularly, for doctors/radiologists to view images contained on thin flexible x-ray film, various film illuminators or light boxes have been developed. These illuminators/light boxes have a translucent front panel mounted in front of a light source. The film is placed in front of the viewing panel, and light from the lamp is diffused through the front panel to backlight the x-ray film to facilitate inspection of the x-ray film.

More particularly, in operation, the doctor/radiologist places the x-ray film image proximate the translucent material to better view the x-ray image. The non-transmitting portions of the light box can be white in color and shaped to promote the light transmission and light uniformity of the light source through the translucent material.

U.S. Pat. No. 4,996,785 (Cicenas), incorporated herein by reference, describes a hanging apparatus for hanging a film sheet in a fixed position against the illuminated viewing screen of the light box.

The light box typically includes a cabinet/enclosure having a viewing panel inserted in the front face of the cabinet and housing a light source. The viewing panel is comprised of an appropriate translucent material such as white diffusing glass, frosted glass, plastic, or Plexiglas, of the like. The translucent material allows appropriate illumination from the back of the film. The light appears uniform but the light source is not clearly visible. The light source can be a lamp, fluorescent lamp, or incandescent lamp. The non-light transmitting surfaces inside the cabinet can be painted white and can be shaped to improve the light transmission out the viewing panel and the uniformity of the light as viewed from the front surface.

Fluorescent lamps, while suitable, have several disadvantages. For example, fluorescent lamp phosphor is temperature sensitive, and therefore can require a significant period of time (perhaps several minutes) to stabilize in light output and color. Further, the brightness of a fluorescent lamp can be difficult to adjust. In addition, there are a limited number of fluorescent lamp colors due to the limited number of phosphor coatings available, making it difficult to optimize the light source to the light transmission film being viewed. Changing of a lamp's color requires the changing of the lamp.

Various types of light sources can produce significant heat. The heat of the light source can cause the light box cabinet/enclosure to heat, thereby heating the film, which could result in a degradation of the film.

Accordingly, there exists a need for a light illumination device for viewing medical x-ray images which overcomes some of the disadvantages noted above.

In addition, medical images are now being captured digitally, for example, using digital radiography (DR) and computed radiography (CR) devices. X-ray film images can be digitized, for example by using a digitizer, to produce a digital medical image. Consequently, digital medical images are now being viewed by radiologist for diagnosis using digital display devices such as a monitor.

Accordingly, there also exists a need for an apparatus and method for viewing digital medical images.

### SUMMARY OF THE INVENTION

An object of the present invention is to provide a light box which overcomes at least some of the disadvantages of existing light boxes.

Another object of the present invention is to provide an apparatus and method for viewing of digital medical images.

Yet another aspect of the present invention is to provide such an apparatus and method that can promote improved imaging when reviewed by a health care professional reviewing the medical image.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a light box assembly for viewing film media. The light box assembly includes an enclosure, at least two light emitting diodes, and a controller. The enclosure includes a translucent viewing panel for removably receiving the film media. The at least two light emitting diodes are disposed within the enclosure and is adapted to illuminate the viewing panel. The controller controls the color of the at least one light emitting diode. The controller includes a color selection member by which a color can be selected by a user wherein the color of the viewing panel is changed responsive to the user's selection of the color.

According to another aspect of the present invention, there is provided an apparatus for displaying a digital x-ray image. The apparatus includes a display adapted to display the x-ray image and a controller in communication with the display for controlling the color of the displayed x-ray image. The controller includes a continuous color palette by which a color can be selected by a user and the color of the displayed x-ray image is changed responsive to the user's selection of the color.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a diagrammatic illustration of a light box in accordance with one embodiment of the present invention.

FIG. 2 shows a diagrammatic illustration of a light box in accordance with the one embodiment of the present invention.

FIGS. 3A-3C show exemplary arrangements for the light emitting diode(s) within the light box's enclosure.

FIG. 4 shows a control member configured to provide a continuous color adjustment of the LEDs.

FIG. 5 shows a diagrammatic illustration of an apparatus for viewing digital medical images in accordance with a second embodiment of the present invention.

FIG. 6 shows a diagrammatic illustration of an apparatus for viewing digital medical images in accordance with a second embodiment of the present invention.

FIG. 7 shows a diagrammatic illustration of an apparatus for viewing digital medical images in accordance with a second embodiment of the present invention.

FIG. 8 shows a diagrammatic illustration of an apparatus for viewing digital medical images in accordance with a second embodiment of the present invention.

FIG. 9 shows a control member configured to provide a continuous color adjustment for the apparatus for viewing digital medical images.

### DETAILED DESCRIPTION OF THE INVENTION

The following is a detailed description of the preferred embodiments of the invention, reference being made to the drawings in which the same reference numerals identify the same elements of structure in each of the several figures.

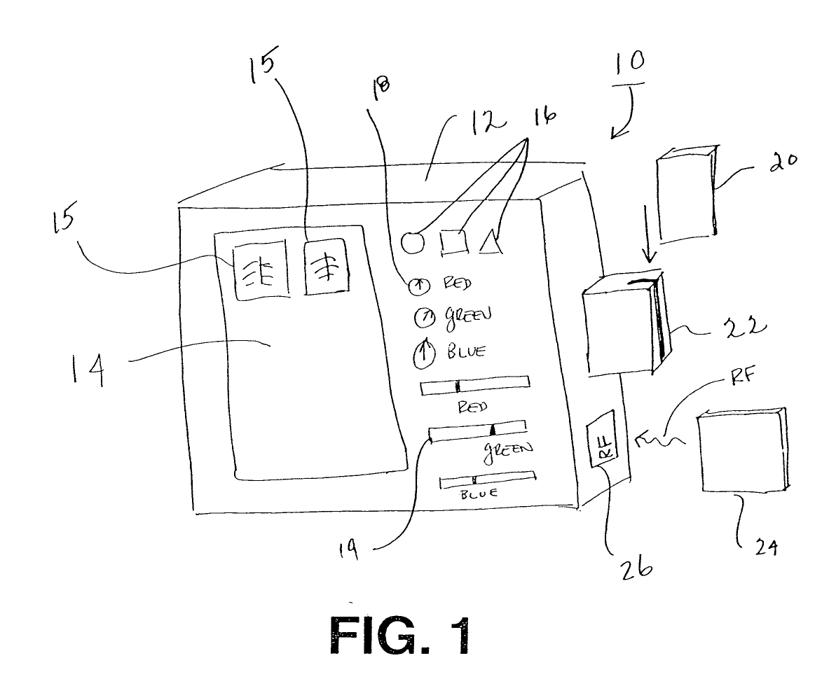

The invention is now described with reference to FIGS. 1-3 which show a diagrammatic illustration of a light box 10 in accordance with the present invention.

Light box assembly 10 includes a housing/enclosure 12 having a viewing panel 14 for receiving an x-ray film/media 15 for viewing by an individual (such as a doctor/radiologist). As indicated above, viewing panel 14 is comprised of an appropriate translucent material such as white diffusing glass, frosted glass, plastic, Plexiglas, and the like which will allow appropriate illumination. Means known to those skilled in the art can be provided to hang film media on viewing panel 14. Light box 10 can further include buttons/knobs/control members 16 for actuating and controlling operation of the light box. For example, an on/off button or a light intensity button or a light color button, as will become more evident with the description below.

Applicant has recognized that doctors/radiologists can be sensitive to variability in color of the film and image when reading films. As such, Applicant has recognized that there is a need for a light box that would allow the brightness and color of the light in back of the image to be adjusted and controlled. Accordingly, housing 12, in accordance with the present invention, houses at least one light source wherein the light source is a light emitting diode (LED) 13. A light box employing LEDs as a light source can provide continuously variable brightness and color. Further, LEDs are not a source of mercury and have a longer life than fluorescent bulbs, thereby reducing or eliminating bulb replacements.

LEDs are well known devices. Since their first development in the 1960s, they have increased in light output and available colors. A breakthrough development occurred in the early 1990s when commercially available blue LEDs became available. With blue, green and red LEDs available, it became possible to produce nearly any color of light by mixing the three colors. An increased light output broadened their potential applications.

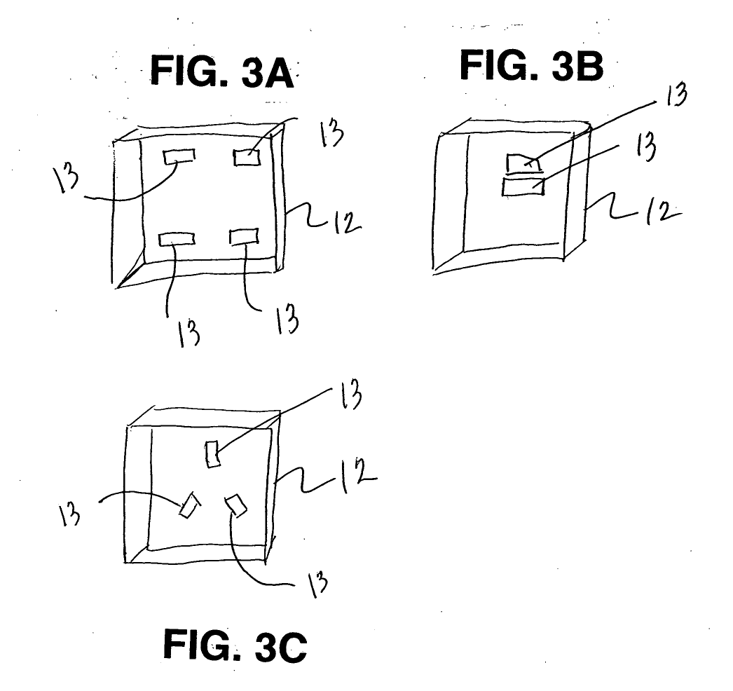

It is noted that one or more LEDs or LED arrays can be employed, and can be arranged in various configurations. FIGS. 3A-3C show exemplary arrangements for light emitting diode(s) 13 within enclosure 12. It is also noted that the LED(s) can be of a white light (as a non-color variable light source) and/or a color light. LEDs can be provided in a variety of colors. In addition, an LED light source assembly can be continuously adjusted for light color over a useful range.

Since LEDs are fairly compact in size, particularly when compared to fluorescent lamps, a light box employing LEDs can be compact in size. That is, the use of LEDs will allow the construction of a thin light box that could be adjusted for light level and color temperature to match any film type. Closed loop control of the color and brightness through a color sensor (such as available from TAOS (Texas Advanced Optoelectronic Solutions Inc.), a company headquartered in Plano, Tex., or Hamamatsu Photonics K.K., a company headquartered in Hamamatsu, Japan) combined with a microprocessor based control system would provide consistency over time and use as well as allow the use of stored custom presets for different film types or user preferences. These features will be more particularly described below.

One suitable LED assembly for the present invention is the DCC range of led light sources available from Lumileds Lighting, a company headquartered in San Jose, Calif. Product information is available from their website at http://www.lumileds.com/products/family.cfm?familyId=17.

Another suitable LED assembly for the present invention is that discussed in “High-efficiency slim LED backlight system with mixing light guide” by Martynov et al, SID 03 Digest, Pages 1-3.

The use of LEDs in light box 10 provides several advantages. For example, LEDs can be made temperature insensitive through closed loop control. That is, they do not require a significant amount of time to stabilize in light output and color. Accordingly, when a doctor/radiologist actuates light box 10, for example by pressing button 16 to turn “on” light box 10, light box 10 will be substantially instantaneously operational. This can provide an energy savings and extended lamp life since the light box does not need to be operational when not in use by a doctor/radiologist.

The brightness of the LEDs can be readily adjusted. That is, the level of light from the LEDs can be dimmed without resulting in a color shift (as would occur in an incandescent light source) or flicker (as would occur with a fluorescent light source).

A sensing member can be employed to detect the presence/absence of film media. For example, a motion sensor(s), well known to those skilled in the art, can be disposed on/near the light box to automatically and instantaneously actuate/turn on the light box when a doctor/radiologist places an x-ray film media on the viewing panel of the light box. Similarly, the motion sensor can deactivate the light box when the film media is removed from the viewing panel of the light box. Having such a “standby” mode/state can improve the energy efficiency and lamp life of the light box.

Those skilled in the art will recognize alternatives to a motion sensor. For example, a flag switch could sense the insertion of film into the light box film holding assembly.

If the light box is maintained in an “on” state, the brightness of the light box might disturb the doctor/radiologist's vision when they remove an x-ray film sheet from the light box. Accordingly, the motion sensor(s) (or switch) can be employed to “dim” (or extinguish) the LED light source when the x-ray film sheet is removed from being adjacent the viewing panel. The LED light source can then be brought back to its non-dim/non-extinguished state when an x-ray film sheet is placed adjacent the viewing panel. As such, the doctor/radiologist's work flow is maintained and their vision is not disturbed by the bright light of the light box.

The mechanisms for heat generation are different in LEDs and fluorescent lamps. In a fluorescent lamp, the heat is generated as current passes through mercury vapor inside the tube. Thus, the entire tube heats up and the source of light and heat cannot be separated. Some LEDs might generate a substantially similar or greater level of heat. However, in LEDs, such as the Lumiled LEDs, the source of light and heat is in the semiconductor die which is attached to a copper heat sink. This copper heat sink is thermally coupled to an additional high thermal conductivity heat path. This allows the heat to be conducted away from the source of light and, effectively, piped away from the film to the back/rear of the light box where it can be dissipated by heat sinks. Thus, by design, the heat can be removed from the vicinity of the film. As such, there can be a reduced likelihood of any film degradation resulting from heat.

Applicant has recognized that doctors/radiologist often have a color preference in which to analyze the content of the x-ray film image. For example, one doctor may prefer a brownish color to the x-ray film image for a particular diagnosis while another doctor may prefer a bluish color to the x-ray film image. Since one light box might be used by a plurality of doctors, employing LEDs can allow a single light box to be employed by a plurality of doctors yet allow each doctor to have their preference.

Individual color (e.g., red, green, blue) control members can be employed by light box 10. For example, as shown in FIG. 1, the control members can be dials (elements 18) or sliding members (elements 19). Alternatively, a joystick or touchpad can be employed. By adjusting the control member, the radiologist can achieve a desired/preferred color.

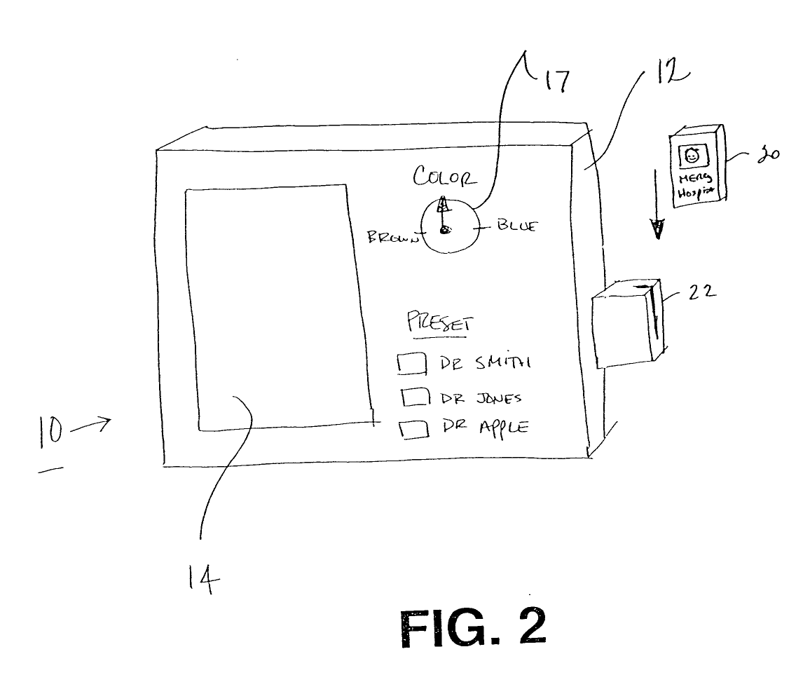

In addition, as shown in FIG. 2, control member 17 can be configured to provide a continuous color adjustment of the LEDs. As shown in FIG. 2, the color could range from blue to brown, though other colors can be achieved. Those skilled in the art will recognize other control members/buttons for providing continuous color adjustment.

Alternatively, user preferences can be preset or customized. As such, a doctor might merely presses a button, as shown in FIG. 2, and the light box would be configured for that particular user's preferences of color, light level, and the like.

Still further, presets for doctor preferences can be maintained in a magnetic swipe card 20 readable by a card reader 22, as shown in FIGS. I and 2. By using card 20, a doctor can present the card to the light box for automatic customization of color preference. That is, card 20 can include information related to predetermined settings (e.g., brightness, color, hue, on-off timing of the light box, and the like). Once the predetermined information is read by reader 22, means (known to those skilled in the art, such as a computer, software, firmware or controller) employed by light box 10 can configure the settings of light box 10 to the predetermined values. Swipe card 20 could be the security/id badge employed by a hospital staff or a separate entity.

Other alternative methods can be employed to obtain the preference presets, and the light box might include one or more such methods. For example, while FIG. 2 shows the use of swipe card 20, FIG. 1 allows/accepts both swipe card 20 and an RFID (radio frequency identification) tag 24 readable by an RF reader 26. By using tag 24, a doctor can present the tag to the light box for automatic customization of color preference. In another example, not shown in the figure, a bar code and a bar code reader can be employed.

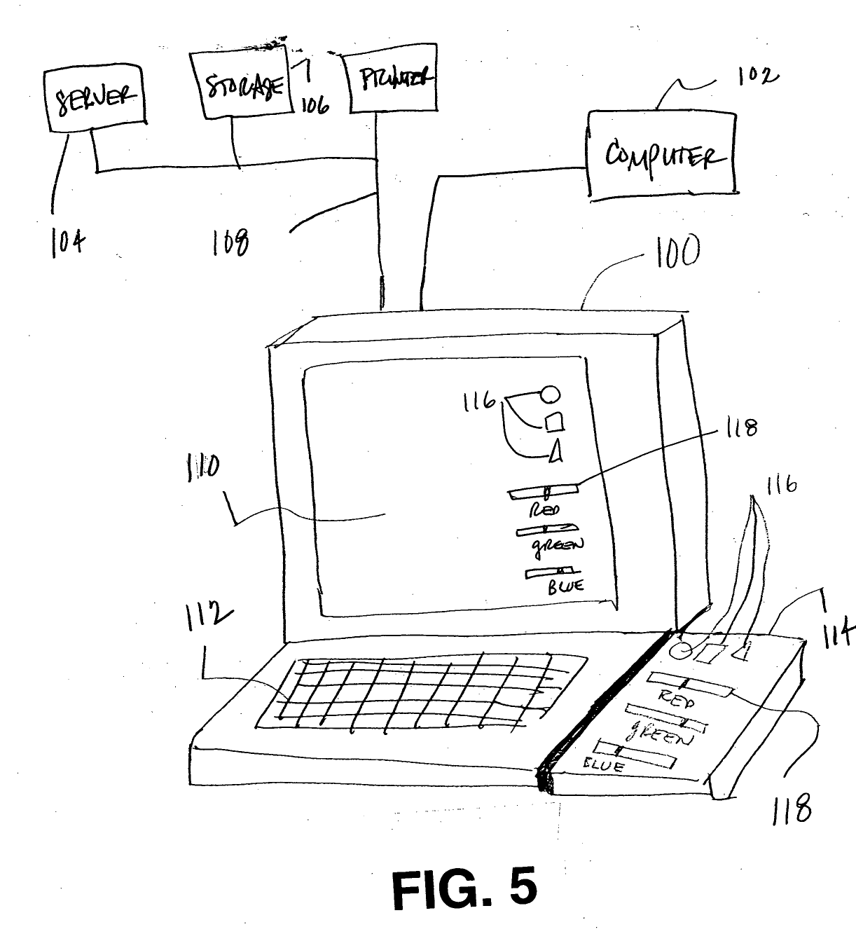

As indicated above, control member 17 can be configured to provide a continuous color adjustment of the LEDs. In one arrangement of light box 10, shown in FIG. 5, control member 17 is in communication with light box 10 using wired or wireless communication means 30, which are well known to those skilled in the art.

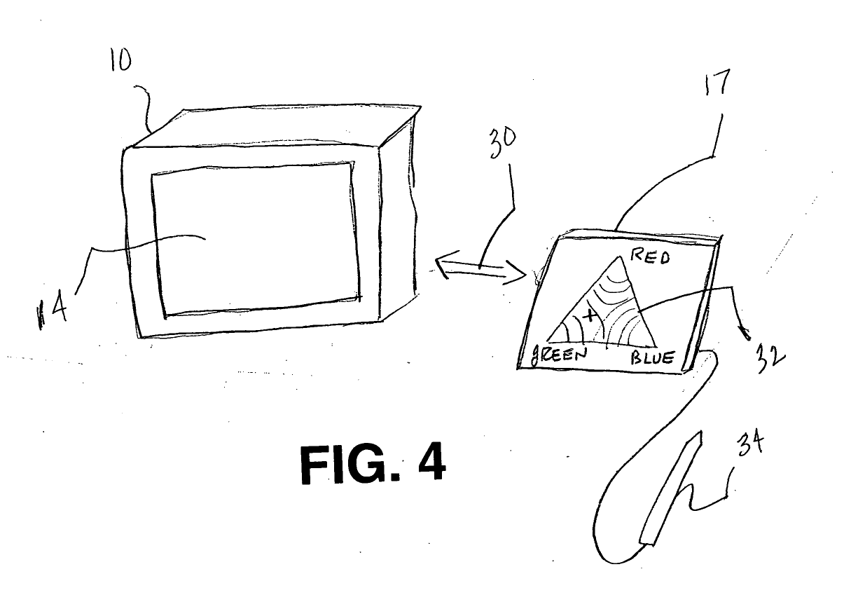

Control member 17 provides for a continuous color adjustment of the color of the displayed digital medical image. The continuous color adjustment is provided by means of a color palette 32 disposed on control member 17. In the arrangement shown in FIG. 4, color palette 32 is triangular in shape with a particular color disposed at each end of the triangle (red, green, and blue are shown in the figure, but other colors might be disposed at each end, for example, cyan, magenta, and yellow). Intermediate each end of the triangle, there is a continuous color chart. A user can use a selection member 34 to indicate/select a particular location on color palette 32. Selection member 34 is shown in FIG. 4 as a wand or pointer, but those others skilled in the art will recognize other suitable selections members which can be used.

The selected location corresponds with a particular color. In response to the selection of a location on color palette 32, the viewing panel will emit the corresponding color.

As shown in FIG. 4, a cross-hair or other symbol can be used as an indicator to the user the current selected color Using selection member 34, a user can readily select various colors on color palette 32 by which to illuminate the film media. As such, subtle features of the image can become more or less apparent to the viewer.

It is recognized that light box 10 shown in FIG. 4 can include devices suitable to control a doctor's preset preference. As described above, these members can include the magnetic swipe card/card reader, RFID tag/RF reader, and/or bar code reader. As such, the doctor has a preferred initial display of the medical image, afterwhich, the doctor can change the color as needed for diagnosis/viewing.

Another embodiment of the present invention is now described with reference to FIGS. 5-9, which is directed to an apparatus and method for viewing of digital medical images.

Applicant has recognized that doctors/radiologists can be sensitive to variability in color when reading a digital x-ray image (from a projection-based imaging modality, as compared to a cross section-based imaging modalities such as CT and MRI). As such, Applicant has recognized that there is a need for a display that would allow the brightness and color of a displayed digital x-ray medical image to be adjusted and controlled.

Applicant has further recognized a need to provide doctors/radiologists with the ability to control the variability in color and contrast (including intensity and brightness) of light employed to view the digital x-ray images. That is, Applicant has noted that the doctors/radiologists' sensitivity to variability in color in the reading/viewing of digital medical images.

The ability to change the backlit color can cause certain features of the image to become more or less apparent, which can be beneficial in the extraction of medical information from these images, particularly subtle features of the image not apparent to the average viewer.

More particularly, doctors/radiologist may have a color preference in which to analyze the content of a medical image. For example, one doctor may prefer a brownish color to the medical image for a particular diagnosis while another doctor may prefer a bluish color to the medical image. In addition, a first color may be preferred to review mammography images, while a second color might be preferred to review a chest image. However, a single digital image display device might be used by a plurality of doctors.

Referring first to FIG. 5, there is shown an exemplary display device 100 for displaying a softcopy of a digital image. The digital image can be accessed from a server/computer/processor 102, or alternatively from a server 104 or storage device 106 by means of a communication network 108.

Display device 100 includes a display I 10 adapted to display a color digital image. Display 110 can be for example, but is not limited to, a computer monitor, a cathode ray tube (CRT), a liquid crystal display (LCD) panel, an organic LED display, and the like. Such displays can provide the resolution needed for displaying a high resolution image suitable for viewing by a doctor/radiologist for general viewing or for diagnostic purposes.

Display device 100 can include one or more data entry devices, for example, a keyboard, mouse, light pen, and the like known to those skilled in the art. A keyboard 112 is shown in FIG. 5. Alternatively, display 110 can be a touchscreen (generally illustrated in FIG. 5 by screen icons).

Display device 100 includes means for providing/controlling the variability in color and contrast. Such control means can be integral or separate from display 110. For example, FIG. 5 shows exemplary control means 114 disposed adjacent keyboard 1 12. Control means 114 can include buttons/knobs/control members 116 for actuating and controlling the operation of device 100.

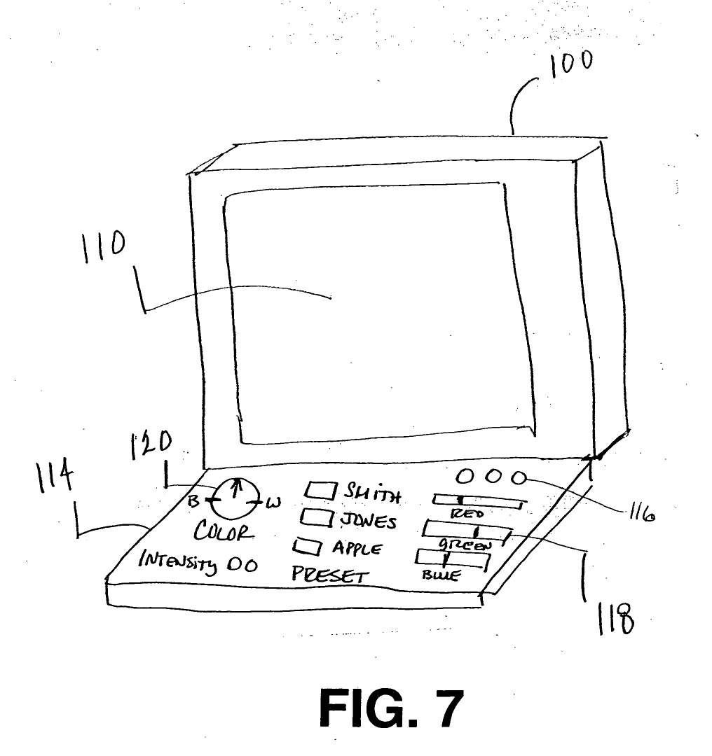

Control means 114 can include individual color (e.g., red, green, blue, cyan, magenta, yellow) control members for controlling the color display of a digital medical image displayed on display 110. For example, as shown in FIG. 7, the control members can be sliding members 118 or dials (not shown, but similar to elements 1 18 of FIG. 5). Alternatively, a joystick or touchpad can be employed. By adjusting the control member, the radiologist can achieve a desired/preferred color of the digital image display on display 110.

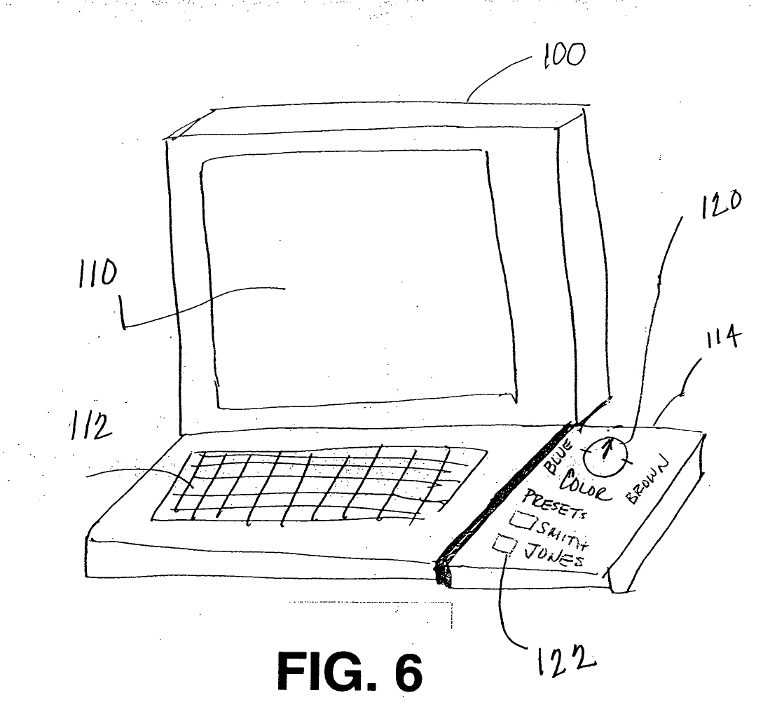

Referring to FIG. 6, control means 114 can include a control member 120 that provides for a continuous color adjustment. As shown in FIG. 6, the color could range from blue to brown, though other colors can be achieved. Those skilled in the art will recognize other control members/buttons for providing continuous color adjustment.

Alternatively, user preferences can be preset or customized. As such, a doctor might press a preset member (such as the button, as shown in FIG. 6 as element 122) wherein display device I 00 would be configured for that particular user's preferences of color, light level, and the like.

FIGS. 5 and 6 shows control means 114 disposed adjacent display 110, but those skilled in the art will recognize that control means 114 and display 110 can be a unitary element to form device 100.

FIG. 7 shows control means 114 have a plurality of control members.

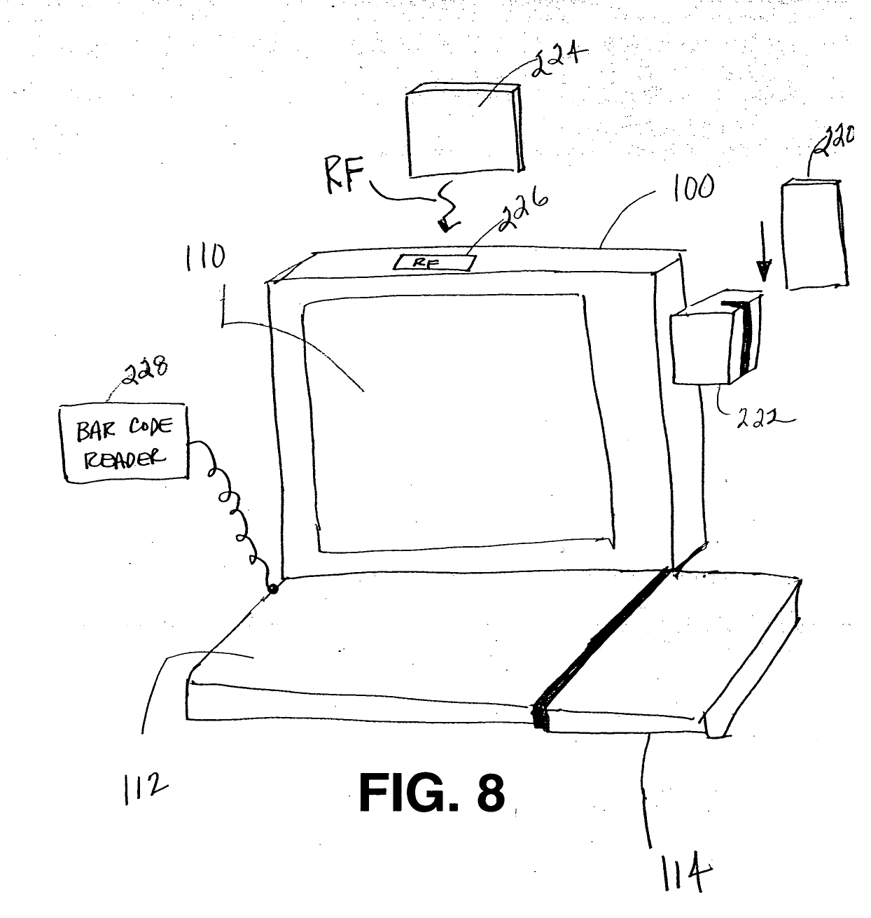

Referring now to FIG. 8, presets for doctor preferences can be maintained using a magnetic swipe card 220 readable by a card reader 222. By using card 220, a doctor can present the card to the light box for automatic customization of color preference. That is, card 220 can include information related to predetermined settings (e.g., brightness, color, hue, on-off timing of device 100, and the like). Once the predetermined information is read by reader 222, means (known to those skilled in the art, such as a computer, software, firmware or controller) employed by device 100 can configure the settings of device 100 to the predetermined values. Swipe card 220 could be the security/id badge employed by a hospital staff or a separate entity.

Other alternative methods can be employed to obtain the preference presets, and device I 00 might include one or more such methods. For example, device 100 can allow/accept both swipe card 220 and RFID (radio frequency identification) tag 224 readable by RF reader 226, as shown in FIG. 8. By using tag 224, a doctor can present the tag to the light box for automatic customization of color preference. Tag 224 could be the security/id badge employed by a hospital staff or a separate entity.

In another example, shown in FIG. 8, a bar code reader 228 can be employed to read a bar code from a member, such as card 220 or tag 224.

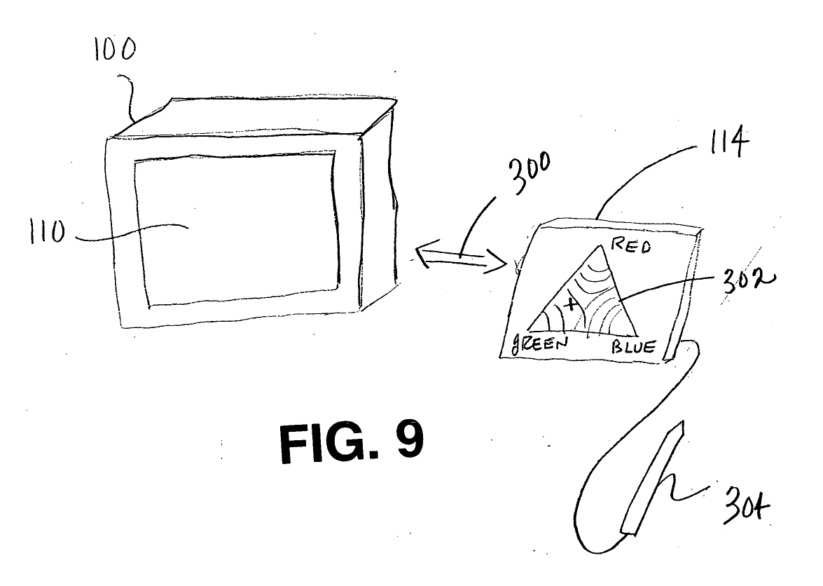

One arrangement of the present invention is shown in FIG. 9. In this embodiment, control means 114 is in communication with display 110 using wired or wireless communication means 300, which are well known to those skilled in the art.

Control means 114 provides for a continuous color adjustment of the color of the displayed digital medical image. The continuous color adjustment is provided by means of a color palette 302 disposed on control means 114. In the preferred embodiment shown in FIG. 9, color palette 302 is triangular in shape with a particular color disposed at each end of the triangle (red, green, and blue). Intermediate each end of the triangle, there is a continuous color chart. A user can use a selection member 304 to indicate/select a particular location on color palette 302. Selection member 304 is shown in FIG. 9 as a wand or pointer, but those others skilled in the art will recognize other suitable selections members which can be used.

The selected location corresponds with a particular color. In response to the selection of a location on color palette 302, the displayed digital medical image will be displayed with the corresponding color.

As shown in FIG. 9, a cross-hair or other symbol can be used as an indicator to the user the current color of the medical image displayed on display 110.

Using selection member 304, a user can readily select various colors on color palette 302 by which to display the digital medical image. As such, subtle features of the image can become more or less apparent to the viewer.

It is recognized that display device 100 shown in FIG. 9 can include devices suitable to control a doctor's preset preference. As described above, these members can include the magnetic swipe card 220/card reader 222, RFID tag 224/RF reader 226, and/or bar code reader 228. As such, the doctor has a preferred initial display of the digital medical image, afterwhich, the doctor can change the color as needed for diagnosis/viewing.

It is noted that the digital display panel can also be employed to view hard-copy images. For example, with an LCD panels, the illumination sources in the panels can provide light-box levels when viewing medical film, but be reduced (throttled back) when viewing normal digital images. The color of the “backlight” would be adjusted, not through LEDs but by means of changes to the LCD panel digital data. Means can be provided to hold/secure the film on the display panel. A sensor could be employed to automatically detect the medical film (and/or film size) and adjust the backlight accordingly. Such a “hybrid” light box could be employed where both film images and digital images are viewed.

All documents, patents, journal articles and other materials cited in the present application are hereby incorporated by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 light box
12 housing/enclosure
13 light-emitting diode(s)
14 viewing panel
15 x-ray film images
16 control members/buttons
17 control member/continuous control
18 control member/dials
19 control member/sliding members
20 magnetic swipe card
22 swipe card reader
24 RFID tag
26 RFID badge
30 communication member
32 color palette
34 selection member
100 display device
102 computer/processor
104 server
106 digital storage
108 network communication
110 display
112 keyboard
114 control means
116 control members/buttons
118 control member/sliding members
120 control member/continuous control
220 magnetic card
222 magnetic card reader
224 RFID
226 RFID reader
228 bar code reader
300 communication
302 color palette
304 selection member

What is claimed is:

1. A light box assembly for viewing medical film media, comprising:
an enclosure having a translucent viewing panel for removably receiving the medical film media;
at least two light emitting diodes disposed within the enclosure adapted to illuminate the viewing panel; and
a controller for continuously controlling the color of the at least two light emitting diodes, the controller including a color selection member by which a color can be selected by a user wherein the color of the viewing panel is continuously changed responsive to the user's selection of the color.

2. The light box assembly of claim 1, wherein the controller includes a triangular shaped continuous color palette by which a color can be selected by the user.

3. The light box assembly of claim 1, further comprising a sensing member adapted to sense the presence of the film media so as to actuate the at least two light emitting diodes responsive to the sensed presence of the film media.

4. The light box assembly of claim 1, further comprising:
a reader adapted to read a predetermined setting from an information member; and
means adapted to configure the light box responsive to reading the predetermined setting.

5. The light box assembly of claim 4, wherein the information member is a magnetic swipe card and the reader is a magnetic card reader.

6. The light box assembly of claim 4, wherein the information member is an RFID tag and the reader is an RF reader.

7. A method of configuring a light box assembly, the method comprising the steps of:
providing the light box assembly, the light box assembly including (i) an enclosure having a translucent viewing panel for removably receiving a film media, (ii) at least two light emitting diodes disposed within the enclosure adapted to illuminate the viewing panel, and (iii) a reader adapted to a read a setting from an information member, the information member being separate and distinct from the light box assembly; and
reading the setting from the information member; and
configuring the light box assembly responsive to the reading of the setting from the information member.

8. The method of configuring a light box assembly of claim 7, wherein the information member is a magnetic swipe card and the reader is a magnetic card reader.

9. The method of configuring a light box assembly of claim 7, wherein the information member is an RFID tag and the reader is an RF reader.

10. An apparatus for displaying a digital x-ray image, comprising:
a display adapted to display the x-ray image; and
control means in communication with the display for controlling the color of the displayed x-ray image, the control means including a continuous color palette by which a color can be selected by a user and the color of the displayed x-ray image is changed responsive to the user's selection of the color.

11. The apparatus of claim 10, further comprising a device adapted to automatically determine a user's preferred color by which to display the digital x-ray image.

12. The apparatus of claim 11, wherein the device is a bar code reader, a RFID reader, or a magnetic swipe card reader.

13. A method of displaying a digital x-ray image on a display, the method comprising the steps of:
accessing the digital x-ray image;
displaying the digital x-ray image on the display;
providing a controller adapted to control the color of the displayed x-ray image, the controller including a continuous color palette from which a particular color is selectable;
allowing a user to select a color from the color palette; and
displaying the digital x-ray image in the selected color responsive to the user's selection of the color from the color palette.

14. The method of claim 13, wherein the step of displaying the digital x-ray image comprising the steps of:
automatically determining a user's preferred color by which to display the digital x-ray image; and
displaying the digital x-ray image in the preferred color responsive to the automatic determination.

15. The method of claim 14, wherein the step of automatically determining a user's preferred color is accomplished by using a bar code reader, a RFID reader, or a magnetic swipe card reader.
